(19) United States
(12) Patent Application Publication
(10) Pub. No.: US 2005/0256621 A1
(43) Pub. Date: Nov. 17, 2005

(54) Protective device for pacemaker patients or stoma patients

(76) Inventor: Gerald Lange, Lutzhorn (DE)

Correspondence Address: DORITY & MANNING, P.A., POST OFFICE BOX 1449, GREENVILLE, SC, 29602-1449, US

(21) Appl. No.: 10/519,516

(22) PCT Filed: Jun. 17, 2003
(86) PCT No.: PCT/EP03/06365

§ 371 Date: Dec. 23, 2004

(30) Foreign Application Priority Data
Jun. 24, 2002 (DE) 102 28 163.7

(51) Int. Cl. G05D 1/00; G06F 7/00

(52) U.S. Cl. 701/45

(57) ABSTRACT

Disclosed is a device for protecting pressure-sensitive, touch-sensitive, or injured parts of the human body when using a belt that is worn on the body, such as a seat belt of a vehicle. Said protective device comprises a side facing the body of the user and an opposite upper side. The inventive protective device is characterized by the fact that the upper side (24) is embodied as a surface which does not comprise any unwanted protrusions or edges.

The present invention relates to a protector for the protection of contact-sensitive or injured points of the human body, e.g. of persons with a pacemaker or a stoma according to the introductory clause of claim 1. The utilization of seat belts in vehicles or on airplanes for the protection from injury in case of accident is now used world-wide and is recognized as a life-saving measure or as a precautionary measure against severe injury. Nevertheless safety systems with belts are not an alternative that is useable by everybody since the belts may have a negative influence on the points of the body on which they act even when worn under normal conditions if the person secured by means of a belt is sensitive to pressure or contact in the area where the belt is applied.

Application of the belt at injured points of the human body or, e.g. at artificial body openings is especially disadvantageous because in such case the wearing of the belt may be excessively uncomfortable or even lead to injury. In particular in case of damaged points of the body, e.g. due to surgical wounds or at points where a pacemaker is implanted, such persons cannot be expected to wear a seatbelt in the area of the affected body points.

Although such persons can be freed of the obligation to wear a seatbelt in street traffic, they must however accept the risk of being injured even in relatively light traffic accidents.

DE 197 29 755 A1 discloses a device to guide a seatbelt across the body of a person secured by it, whereby the seatbelt is lifted from a predetermined body point of the person. The device can be displaced on the belt in this case. It is attached to the belt via shackles that reach across the belt partly from the side. The shackles provide in this case a distance between the device and the belt whereby the belt can easily be pushed through. This device has the disadvantage that the device can shift accidentally on the belt so that the sensitive point of the body can be put at risk as a result.

For installation on the belt, the latter must alternately be introduced below one shackle and then the other, causing the belt to be deformed to a great extent. The shackles are narrow and are not covered on the side away from the wearer's body. On that side they have narrow edges which are rounded off with small radii only, so that the danger of damage to an opening airbag exists if the device is worn in a motor vehicle.

In a different application of the device, e.g. to protect the body from a belt of a garment, these shackles cause the device to be of little use. The shackles render the position of a belt or e.g. also of a tight waistband unstable so that such an application of the device has only very limited possibilities. In addition such a device has the additional disadvantage that if it is used in a vehicle equipped with an airbag, the danger exists that it may damage the latter, in particular during the opening phase.

U.S. Pat. No. 3,386,103 discloses a device that is provided with openings at both ends through which the belt is introduced into the inside of the device. For this purpose the belt must be threaded through the openings. The lock of the belt is contained inside the device in order to protect the wearers body from the additional pressure of the belt lock such as used on airplanes, for example. This device is very crude in form whereby the edges may have relatively sharp angles.

It is the object of the present invention to design a protector in such manner that the disadvantages of the device according to the state of the art may be reduced and so that the protector can be attached securely on the belt of a motor vehicle or airplane, being furthermore flexible, also for the protection of clothes at compression points. Furthermore a protector is to be improved so that the device may not be a risk to an airbag if the latter should be opened in case of an accident.

This object is attained through the characteristics of the invention according to claim 1.

The design of the protector according to the invention advantageously ensures that the protector is able to interact without any problem with other safety systems, in particular with an airbag. Since the upper side of the protector which is away from the wearer is preferably given a surface according to the invention so as not to be interrupted by protrusions or edges and not to be interfered with in any other manner, an airbag cannot be damaged. The upper side is advantageously free of corners, edges, protruding parts or interruptions of the surface that would be rough, with sharp edges or pointed, which could lead to damage. The upper side has thus a rather smooth surface, where “smooth” is meant to mean “even”. A convex or curved upper side also meets these criteria. Thereby no interference with other safety systems such as e.g. airbags can occur. The impact of an opening air bag against the protector according to the invention cannot cause its function to be influenced negatively. In an advantageous further development of the invention the upper side is not interrupted by fastening means of the belt, i.e. these are not located on the upper side or formed on it. In the same way the upper side is not interrupted by guiding means for the belt nor are these installed on it. These are advantageously located underneath the upper side or at its ends or at the ends of the protector.

The upper side according to the invention extends advantageously over the entire length of the protector. As a result this ensures that the essential areas of the protectors coming into contact with an airbag present no problem for the airbag. The area at the ends of the protector need not be included in the upper side designed according to the invention if the ends cannot come into contact with the airbag because of their or the protector's configuration.

In an advantageous embodiment of the protector according to the invention, the upper side also constitutes the support side for the belt, whereby the holding and guiding means of the belt according to the invention must in that case be located outside the upper side of the belt in order to avoid damage to or endangerment of an airbag and also of the belt.

Thanks to the advantageous design of the invention in which the protector is made in several parts, in particular consisting of a basic bode and a cover, the goal is achieved that the belt can be held reliably on the protector and at the same time that the protector can be installed rapidly on the belt while providing also easy handling. In addition, this design can easily meet the requirement that the device may take effect together with an airbag. The protector is here advantageously capable of being moved on the belt so that it can be positioned at the correct location of the belt in order to be used at the correct point of the body.

At the same time the possibility is provided for the belt to be removed from the body, e.g. when exiting a vehicle, without requiring the removal of the protector from the belt. It remains advantageously on the belt and can be place in a position in which the belt, e.g. an automatic seatbelt of a vehicle, is able to move into its rest position.

Thanks to the design of the device according to the invention through which the different sources of danger to an airbag are all covered by the cover on the protector it is not necessary to relinquish the different element and these can be designed freely on the protector. The protector is then prepared in such manner by the cover that it can also interact with other, sensitive safety systems. Thanks to the special design of the protector, whereby the latter has no components protruding beyond the upper side in the direction of the user, any risk to an airbag can be eliminated reliably.

The design of the upper side is especially advantageous if it is curving in the direction of the course of the belt. This is because in that way, when the belt is directly in contact with the upper side, it lies securely on the protector and the upper side also has an advantageous form making risk-free interaction with an airbag possible. This applies similarly to the other claimed curvatures of the upper side.

In an especially advantageous further development of the invention the basic body and the cover are designed so that the belt can be guided securely in the protector because the cover and basic body enclose the belt between them. The two can then interact advantageously if the cover can move at least in some areas relatively to the basic body. Thereby the protector can be easily attached to the belt because the cover can be removed at least in part for that purpose. The cover can be shifted on the basic body for this, for example, or the cover can be unhinged, swiveled away or can be moved away in some other known manner from the basic body.

In an especially advantageous embodiment of the invention the cover is made in form of a guide. The cover thereby serves advantageously also to guide the protector on the belt. For this purpose the cover is especially advantageously made so as to be capable of swiveling at least in part on the basic body. This ensures that the belt can be installed very simply and rapidly on the belt. Thanks to its ability to swivel the protector is opened so that the belt can be inserted, whereupon the cover can be closed again so that the cover holds and guides the belt against the basic body.

In another advantageous embodiment of the invention the cover is at least partially detachable from the basic body. This makes an easy introduction of the belt into the protector possible and at the same time provides the possibility of producing a protector economically and e.g. advantageously also by means of injection molding.

The design of the cover as a guide of the belt advantageously makes it possible not only for the belt to be held securely on the protector but also extends in a protected manner inside the protector. In addition the cover can also be provided with tappets that are able to more or less oppose the shifting of the protector on the belt so that it essentially remains in its position on the belt. The cover is advantageously installed in such manner on the protector that it is located on the side of the basic body of the protector away from the user's body.

In an advantageous further development of the invention a distance exists between the basic body and the cover, this distance being designed so that the belt is able to shift only in a braked manner on the basic body. This prevents the protector from accidentally leaving its position on the belt. The distance between the basic body and the cover is here designed in such manner that the belt can be simultaneously in contact with the basic body and the cover. The shifting ability can thereby be adjusted precisely to the desired value.

It has advantageously appeared that the distance between the basic body and the cover measures advantageously less than 2 mm at least at some points. Thereby sufficient space is available for the belt to be received on the protector while at the same time providing a distance ensuring a braked displacement of the protector on the belt. It is especially advantageous in this case for the distance to measure less than 1.5 mm, preferably less than 1.3 mm because thereby as a result the basic body and the cover interlock together with the belt without any additional measures, while this interlocking connection can however easily be overcome by a person so that precise adjustment of the protector on the belt becomes possible. Advantageously tappets are formed for this purpose on the cover, defining the smallest distance between the cover and the basic body, whereby a precisely fitting design of the device is necessary at only few points, so that it can be produced economically. Injection molding tools in particular, are thereby considerably less expensive.

In an advantageous further development of the invention the protector according to the invention has bearing surfaces by means of which it bears on the body of the user and thereby lies against the body. The other parts of the protector are thus not applied to the body and ensure comfortable wearing of a belt, e.g. a seatbelt.

In an advantageous further development of the invention the bearing surface can be provided with a coating that may be bonded to it for example, and has buffering properties. Thereby comfortable wearing on the body is possible while at the same time the pressing of the protector by the belt against the body during an accident ensures that no injuries are caused by the protector on the body of the wearer. Good buffering properties are found e.g. in coatings made of rubber or rubber-like materials. These can be glued simply to the basic body or can be attached in some other suitable manner.

It is especially advantageous if the coating has at the same time the characteristic of increasing the friction between protector and body or clothing, so that if the wearer of the protector moves when strapped in, the protector remains at the correct body location. In this case the frictional conditions are advantageously designed so that the belt is able to move inside the protector when the body moves, while the protector remains on the body itself as a result of greater friction, advantageously at the predetermined point. This ensures greater safety because the protector remains at the predetermined point, even if the wearer of the protector moves while strapped in, e.g. in a motor vehicle. In addition this ensures that the belt is able to move within the protector even if a predetermined force must be overcome for this. The protector nevertheless remains in position on the body. The design of these two characteristics of the protector must be coordinated accordingly with each other so that an especially advantageous embodiment of the invention is achieved.

In an advantageous further development of the invention the protector is provided with a bridge-like structure between the bearing surfaces, guiding the belt over the sensitive body point. In an advantageous further development the change-over between the bearing surface and the bridge-like part of the basic body is rounded in order to avoid injuries. A radius of at least 0.5 mm, preferably at least 1.5 mm has been shown to be advantageous and sufficient in this case.

In an advantageous further development of the invention the cover is provided with a lateral opening in the plane of the belt which in addition can advantageously be closed up. This makes an easy introduction of the belt into the cover as well as at the same time an economic embodiment of the protector possible.

In an advantageous further development of the invention the cover and/or the basic body is provided with a coating, e.g. by gluing on the surface, on the side towards the belt, increasing the friction between protector and belt. This makes it possible to still pull the belt through the protector, whereby at the same time this is only possible if it is wanted by the user of the protector. A precise frictional value between protector and belt can be realized advantageously through different kinds of coatings. It is advantageously designed so that free displacement of the protector on the belt is not possible. Free displacement means here that the protector shifts along the belt e.g. due to vibration or gravity alone.

An advantageous embodiment of the cover is achieved if it is designed in such manner as to be capable of displacement on the basic body. Thereby it is easily produced and an introduction of the belt is easily carried out even by untrained persons. In another advantageous embodiment of the invention the cover is essentially positioned at a right angle to the belt on the basic body, so that easy introduction of the belt between basic body and covering is also easily achieved. In this embodiment it is furthermore possible to make cover and basic body in one piece and to achieve swiveling e.g. especially advantageously by means of injection-molded hinges on an injection molded part.

In another embodiment of the invention the cover or the attachment on the basic body is realized by means of a snap-in connection, so that a secure connection between basic body and cover is possible. This furthermore requires no tool and can easily be achieved, e.g. also through injection molding. In another advantageous embodiment of the invention the cover is made in several arts, whereby one part is formed on the basic body, e.g. in a non-detachable manner, e.g. when both are produced in form of injection-molded parts and can therefore be produced in one operation. For the secure attachment of the protector on the belt, the other part is attached on the basic body or on the cover, whereby this can also be done in one or multiple parts, whereby the other part is advantageously capable of being displaced or swiveled.

By designing contact surfaces on the cover in order to guide the belt by means of these, easy gliding of the belt through the protector is made possible, especially through lateral contact surfaces for the belt. Thanks to the advantageous embodiment of the surface of the basic body towards the belt, in form of a curved, flat surface, the force of the belt is distributed evenly over the basic body in case of an accident.

Thanks to the advantageous design of the basic body, with rounded edges, the area of the protector which is not covered by the protector is configured so that it presents no danger for any parts coming into contact with it, in particular for an airbag.

The invention is explained below through drawings:

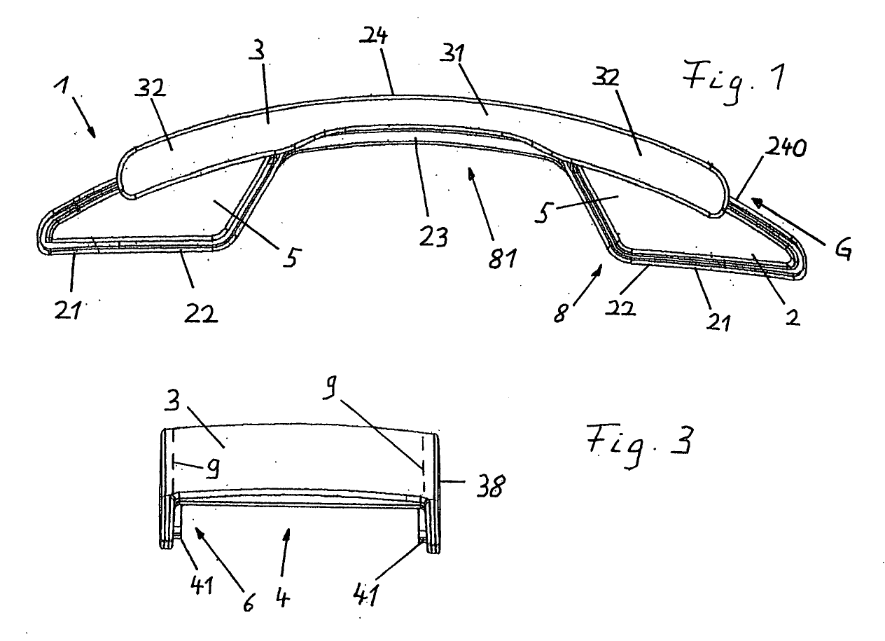

FIG. 1 shows a lateral view of a protector 1 according to the invention,

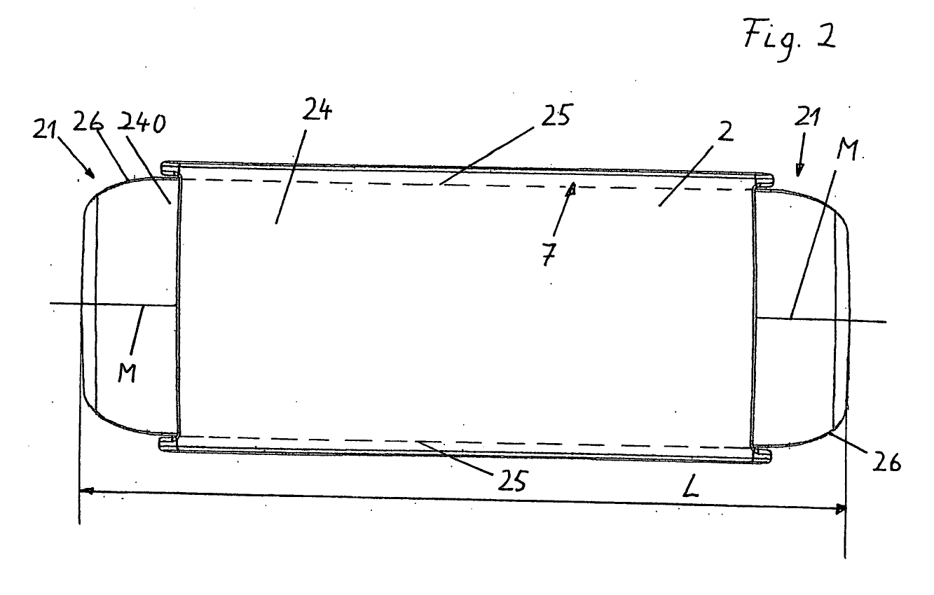

FIG. 2 shows a top view of the protector of FIG. 1,

FIG. 3 shows the right lateral view of FIG. 2.

The protector 1 consists of a basic body 2 and a cover 3 for a belt (not shown) interacting with the protector 1 in the case of deployment. At each of its ends the basic body 2 is provided with two bearing surfaces 21 by which it lies against the body of a person in case of deployment. The surfaces 21 are advantageously provided with a coating 22 consisting of a rubber-like material so that when the belt transfers a stress to the protector 1, the latter is able to bear in a buffered manner upon the body of a person. At the same time the coating 22 possesses the characteristic that it offers great frictional resistance so that it does not easily shift on the body or the clothes of the wearer, even in case of an accident. This ensures that the protector 1 remains at the body location where it is needed in an emergency. The frictional resistance is in this case designed so that the belt shifts in relation to the protector 1, in particular in case of stress applied to the belt in the longitudinal direction of the protector 1, while the basic body 2 remains with its surfaces 21 in its position on the body or clothes of a wearer. This ensures that the protector 1 is able to assume the protective function for the endangered or sensitive body point also in such an event. The basic body is provided with a link 23 between the two surfaces 21 to take the belt lying on the basic body 2 across the sensitive point of the body located between the two surfaces 21. The basic body or its link 23 does not touch this point of the body in that case.

The basic body 2 of the protector 1 has an essentially smooth, arc-shaped surface on its upper side 240 away from the body of a wearer. Thus the belt is in contact with the basic body 2 on the upper side 240 of the basic body 2 in case of deployment. The upper side 240 has no lateral rims to guide the belt lying on it, this having the advantage that the basic body 2 can also be used for this, e.g. to \take the belt of trousers across a sensitive or endangered point of the body. The smooth upper side has in this case the special advantage that the basic body 2 can be pushed by the wearer e.g. under a belt without having to overcome a resistance. The lateral guidance of a belt to which the protector 1 is attached is assumed by the cover 3 by means of stop surfaces 9 (see FIG. 3).

In special application it may however also be possible to provide the upper side 240 of the basic body 2 with a guide 7, for instance a lateral border, for the belt. In this case this guide may be located on one or the other edge or on both edges 25 of the basic body 2 (for this see the top view of the basic body 2 in FIG. 2, where the edges 25 are indicated by broken lines since they are covered). With such a design of the protector 1 it is especially advantageous to provide it with a cover 3 as shown in FIG. 2 in order to exclude the risk of damaging an airbag in case of deployment, as the latter then comes into contact with the upper side 24 of the cover 3 according to the invention.

When utilizing the protector 1 shown in FIG. 1, the basic body 2 of the protector 1 is provided with a cover 3 extending over a substantial portion of the length L of the protector 1. The ends 26 (see FIG. 2) are not covered in that case. This is not necessary because on the one hand the ends 26 are rounded off and on the other hand the ends 26 are located so much closer to the body of a wearer than the upper side 24 of the cover 3 that no danger of damage exists for an airbag in case of deployment.

The cover 3 in the embodiment of FIG. 1 serves in addition to connect the belt to the protector 1. When the protector 1 is attached to the belt, the belt extends between the basic body 2 and the cover 3 in the direction of arrow G.

FIG. 2 shows the top view of the basic body 2 of FIG. 1 with an installed cover 3. In the area of the surfaces 21 the ends 26 of the basic body 2 are rounded off. This has in particular the advantage that no sharp edges are present which could cause damage to an airbag in case of deployment.

FIG. 3 shows a side view of the cover 3 of FIG. 2 from which it can be seen that the cover 3 is provided with mountings 41 on the side 4 towards the basic body 2 to serve as fastening means 6 of the cover 3 on the basic body 2. Here the mountings 41 reach around the upper side 240 (see FIG. 1) of the basic body 2, so that a movement at a right angle to the upper side 24 of the basic body 2 is no longer possible. With an attachment of this type of the cover 3 on the basic body 2 the cover 3 is guided alongside the upper side 240 of the basic body for installation or removal. In order to achieve a rigid attachment of the cover 3 on the basic body 2, e.g. a clip-on connection or snap-in connection may be provided, whereby the mountings 41 snap into special recesses of the basic body 2. The cover 3 is thereby held in place.

In FIG. 1 it can be seen that the cover 3 does not reach around the basic body 2 in its central area 31 but only at the end zones 32 following the central portion 31. To ensure easy sliding of the cover 3 on the basic body 2, the basic body 2 and the cover 3 have the same curvature, as can be seen in FIG. 1.

In order to save as much weight as possible the surfaces 21 are reinforced only along a link 23 through which they transmit the forces exerted by a belt on the protector to the surface of the upper side 240 and to the supporting surfaces 21, said link 23 running parallel to the center line M (see also FIG. 2). The change-over 8 to the bridge-like part 81 is rounded off in order to exclude injuries of the body of the user of the protector.

For the lateral guidance of the belt on the protector 1, the cover 3 is provided with lateral contact surfaces 9 (see also FIG. 3). These prevent the belt which lies on the upper side 24 of the basic body 2 from slipping out laterally from the protector 1. To install the protector 1 on a belt, the cover is displaced along the upper side 240 of the basic body 2 in the embodiment shown and is then lifted off from the basic body. Following this the belt can be place don the upper side 240 of the basic body and the cover can be slipped on once more. In another embodiment not shown here the lateral part 38 of the cover 3 can be removed or opened and thereby the gap between the upper side 240 of the basic body 2 and the cover 3 can be opened and the belt can be slipped laterally on the upper side 240 of the basic body basic body 2. The lateral part 38 is then closed again, so that it is impossible for the belt to slip out of the protector. To open and close the cover 3 as well as to attach it, different embodiments are possible and can be used, as long as they serve the purpose of the invention.

In addition it is also possible to form the tappets or ridges on the basic body or cover in a suitable manner so as to obtain a desired distance between the basic body and the cover. If the protector is configured without a cover, measures must be taken to ensure that the means fastening the protector on the belt do not interrupt the upper side 240 of the basic body according to the invention. The upper side 240 of the basic body 2 becomes in that case the upper side 24 of the protector 1 which may come into contact with an airbag in case of deployment and must therefore be designed according to the invention.

1. Protector for the protection of pressure-sensitive, contact-sensitive or injured points of the human body when using a belt worn on the body such as e.g. a seatbelt of a vehicle, whereby the protector has a side toward the user and an upper side away from the user, characterized in that the upper side (24) is a surface that is uninterrupted by protrusions or edges.

2-38. (canceled)
